(19) United States
(12) Patent Application Publication
(10) Pub. No.: US 2026/0024461 A1
(43) Pub. Date: Jan. 22, 2026

(54) I-DRIVEN ENHANCED DICTIONARY DEFINITION FOR AN EDUCATIONAL SYSTEM USING INTEGRATED PROGRAMMATIC CONTROLLED AND SPECIALIZED GUIDED AND CONSTRAINED ARTIFICIAL INTELLIGENCE

(71) Applicant: 2hr Learning, Inc., Austin, TX (US)

(72) Inventor: Simon Said, Malta (MA)

(73) Assignee: 2hr Learning, Inc., Austin, TX (US)

(21) Appl. No.: 19/273,046

(22) Filed: Jul. 17, 2025

Related U.S. Application Data
(60) Provisional application No. 63/672,370, filed on Jul. 17, 2024.

(51) Int. Cl. G09B 17/00

(52) U.S. Cl. CPC G09B 17/003

(57) ABSTRACT

AI-driven definition generation system and method disclosed herein guides an artificial intelligence (AI) engine to provide contextually relevant definitions of words given in a passage. The AI-driven definition generation system includes an online learning platform such that a user can select any word given in a passage on the online learning platform to instantly receive a contextually relevant definition of the selected word. The definition is generated as per the reading level of the user and the context of the surrounding passage. The AI-driven definition generation system achieves this by integrating user profile information, analyzing the surrounding text of selected words, and using an AI engine guided by a content generation system.

### CROSS-REFERENCE TO RELATED APPLICATION(S)

This application claims the benefit under 35 U.S.C. § 119(e) and 37 C.F.R. § 1.78 of U.S. Provisional Application No. 63/672,370, which is incorporated by reference in its entirety.

### FIELD OF THE INVENTION

The present invention relates in general to the field of electronics, and more specifically to an AI-driven definition generation system with an online learning platform that dynamically provides word definitions in correspondence to the context of the passage and the user's reading level which enhances comprehension and makes learning more engaging and effective.

### BACKGROUND OF THE INVENTION

Building a reading habit can be a challenging task for readers at all age levels. One of the main problems faced by new readers is that they often encounter words they do not understand, which can lead to lack of interest in reading. Comprehending complex sentences and unfamiliar words can be overwhelming for readers.

Most of the new-age learning apps come with robust built-in dictionaries that can assist readers without significant interruptions. However, the built-in dictionaries pose a significant challenge in providing accurate, contextually appropriate, and easily understandable word definitions. The language used in defining the meaning of words in these conventional resources is frequently too advanced for readers with limited language proficiency, creating a barrier to understanding. As a result, the reader is required to perform sequential searches to comprehend the word, which disrupts the reading flow and leads to a loss of focus and interest in reading.

Moreover, the built-in dictionaries typically do not include all word variants (e.g., verb tenses and noun plurals). Therefore, words in a reading passage must be pre-processed using lemmatization, stemming, and other techniques to identify the “root” word found in the dictionary. However, these processes can sometimes result in incorrect definitions; for instance, lemmatizing “outdoor” yields “door,” which has a completely different meaning. Misleading definitions hinder the learning process, as users may memorize incorrect meanings or fail to grasp the correct usage of words.

Some of the approaches used to solve the above-discussed issues have included the integration of basic dictionaries into reading apps, where children could look up words manually. However, these dictionaries were not context-sensitive and did not adjust the complexity of definitions according to the reader's age or reading level. Some reading apps attempted to address the reading level appropriateness by providing different dictionary modules for different age groups, but these solutions were still static and did not adapt dynamically to the individual user's comprehension skills or the specific textual context. Alternatively, some apps may manually curate these definitions, which requires significant manual effort.

The current versions of dictionaries built-in reading apps lack technology, context awareness, and personalization. Therefore, there is a need for a more advanced built-in dictionary that can support readers in efforts to enhance vocabulary and build interest in reading.

### SUMMARY

In at least one embodiment, a method integrates programmatic control and a guided and constrained Artificial Intelligence (AI) engine to provide contextually relevant word definitions of words present in a passage. The method includes executing code using one or more processors of a computer system to cause the computer system to perform operations. The operations include selecting a word by the user while reading the passage on the online learning platform, where the selected word is the word whose meaning is difficult to understand by the user. The method further includes fetching user details from a user profile, including user preferences, the user's reading level, and text adjacent to the selected word, where the text adjacent to the selected word is used for determining the context of the selected word within the passage. The method includes generating a prompt to guide the AI engine based on the selected word, user preferences, the user's reading level, and the context of the selected word within the passage. The method also includes transferring the generated prompt to the AI engine to generate the contextually relevant definition of the selected word by the user. Finally, the method includes receiving the contextually relevant definition of the selected word by the user, where the definition is generated following the user's reading level and the context of the passage.

In at least one embodiment, a system integrates programmatic control and a guided and constrained Artificial Intelligence (AI) engine to provide contextually relevant word definitions of words present in a passage. The system includes one or more processors of a computer system and a memory, coupled to the one or more processors, storing code that, when executed, causes the computer system to perform operations. The operations include selecting a word by the user while reading the passage on the online learning platform, where the selected word is the word whose meaning is difficult to understand by the user. The system further includes fetching user details from a user profile, including user preferences, the user's reading level, and text adjacent to the selected word using a data collector, where the text adjacent to the selected word is used for determining the context of the selected word within the passage. The system includes generating a prompt by a prompt generator to guide the AI engine based on the selected word, user preferences, the user's reading level, and the context of the selected word within the passage. The system also includes transferring the generated prompt to the AI engine to generate the contextually relevant definition of the selected word by the user using a definition generator. Finally, the system includes receiving the contextually relevant definition of the selected word by the user using the definition generator, where the definition is generated following the user's reading level and the context of the passage.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary definition generation system within an online learning platform.

FIG. 2 depicts an exemplary definition generation process within an online learning platform.

FIG. 3 depicts a flowchart showing the steps of definition generation within the online learning platform when the user faces difficulty in understanding the meaning of a word.

FIG. 4 depicts an exemplary user interface disclosing a passage and quiz questions that are read by the user.

FIG. 5 depicts an exemplary user interface disclosing the selection of words by the user and the definition of the selected word, which the user faces difficulty while reading.

FIG. 6 depicts an exemplary user interface disclosing the definition of the word selected by the user in context with the passage.

FIG. 7 depicts an exemplary user interface disclosing the comparison between the definition of the selected word and the general definition of the word found in the web.

FIG. 8 depicts an exemplary network environment in which the system of FIG. 1 and the process of FIG. 2 may be practiced.

FIG. 9 depicts an exemplary computer system.

### DETAILED DESCRIPTION

AI-driven definition generation system and method disclosed herein guides an artificial intelligence (AI) engine to provide contextually relevant definitions of words given in a passage. The AI-driven definition generation system includes an online learning platform such that a user can select any word given in a passage on the online learning platform to instantly receive a contextually relevant definition of the selected word. The definition is generated as per the reading level of the user and the context of the surrounding passage. The AI-driven definition generation system achieves this by integrating user profile information, analyzing the surrounding text of selected words, and using an AI engine guided by a content generation system.

Moreover, the AI-driven definition generation system features real-time tracking of user progress and updating reading levels based on quiz results, where the quiz is given in real time according to the content of the given passage. This ensures the definitions remain appropriate and helpful as the user's skills improve over time. Moreover, the output generated by the AI engine includes its phonetic spelling and parts of speech. Providing instant, personalized vocabulary support that evolves with the user, The AI-driven definition generation system aims to enhance reading comprehension, engagement, and overall learning outcomes in digital educational environments.

The AI-driven definition generation system offers significant improvements over conventional definition generation systems in addressing users' comprehension challenges. Traditional approaches often present multiple definitions for a single word. The traditional approaches can confuse users trying to understand the specific context of their reading. In contrast, The AI-driven definition generation system provides real-time, contextually relevant definitions, along with phonetic spellings and parts of speech. This targeted approach helps users comprehend the text more effectively, maintain focus while reading, and avoid frustration when encountering unfamiliar words. Furthermore, the AI-driven definition generation system addresses the issue of definition complexity that often arises in conventional methods. Instead of requiring users to navigate through multiple definitions sequentially, the AI-driven definition generation system dynamically assesses the user's reading level through real-time quizzes and platform interactions. Based on the user's performance in these quizzes, the AI-driven definition generation system tailors the complexity of definitions to match the user's current comprehension level. This adaptive feature ensures that users receive definitions that are neither too simple nor too complex, optimizing users' learning experience and promoting a better understanding of the text.

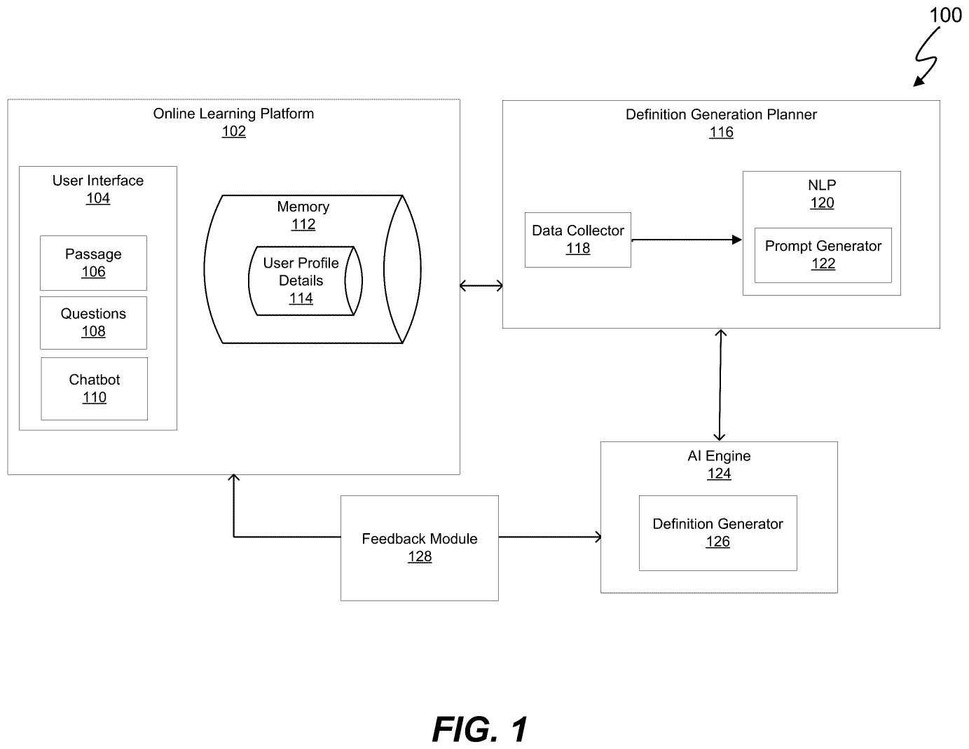

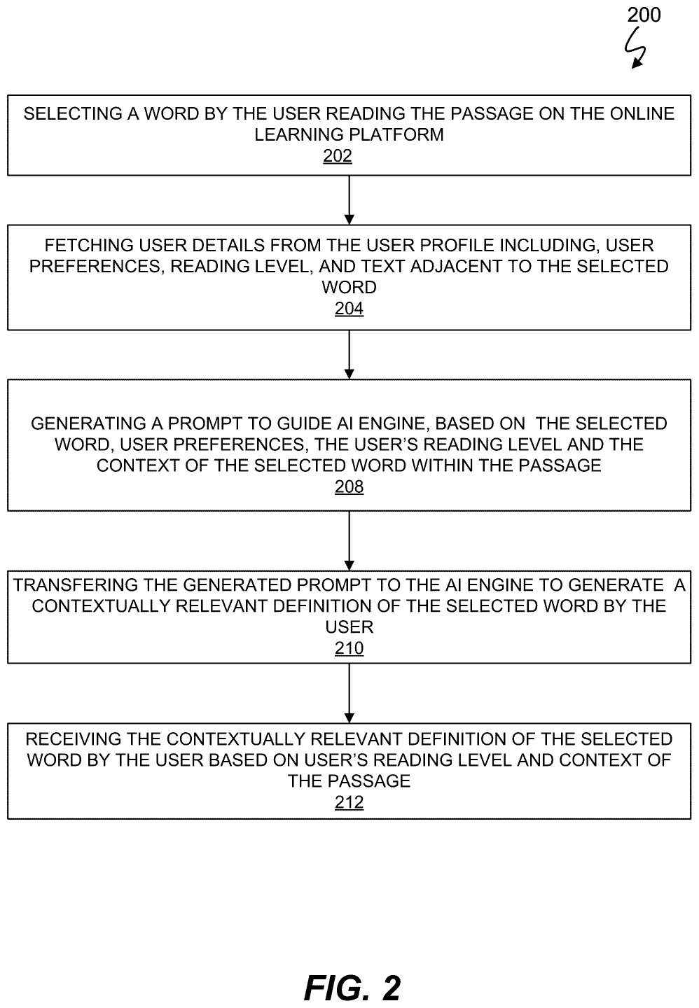

FIG. 1 depicts an exemplary AI-driven definition generation system 100 within an online learning platform 102. FIG. 2 depicts an exemplary AI-driven dictionary process 200 with the online learning platform 102 utilized by the AI-driven definition generation system 100.

Referring to FIGS. 1 and 2, in operation 202, a user interface 104 displays a passage 106 to the user. The user selects a word from passage 106, that the user finds difficult to understand while reading passage 106.

Passage 106 can be any story, news theme, or any other such thing. Questions 108 are also provided along with passage 106 to determine the user's reading level. The words that the user finds difficult to comprehend when selected. The selection of the word 110 fetches it for determining the definition.

The user interface 104 is integrated into the online learning platform 102. The user interface 104 includes the passage 106 which is read by the user, and the question 108 is generated in correspondence to the passage 106 to check the reading level of the user and determine whether the user is able to understand the passage 106 or not. The user interface 104 also includes a chatbot 110 using which the user can provide the answers to the questions 108 and the feedback.

In operation 204, a data collector 118 fetches user profile details 114 from the user profile including, user preferences, user's reading level, and text adjacent to the selected word. The text adjacent to the selected word is used for determining the context of the selected word within passage 106.

The data collector 118 is integrated into a definition generation planner 116, which is operatively coupled to the online learning platform 102. The data collector 118 fetches user profile details 114 stored in memory 112 of the online learning platform. The user profile details 114 include user preferences and the user's reading level. Further, the data collector 118 also fetches the word selected by the user from the passage 106, which the user faces while speaking. This includes the word selected by the user and the context behind the word selected by the user.

The reading level is determined by putting questions 108 to the user while reading passage 106 to determine whether the user can comprehend the meaning of the given passage 106. When questions 108 are answered the reading level will be updated. For updating the reading level, the time taken to finish question 108 is also considered. The user preferences the area of interest that the user has. For example, after reading passage 106 regarding the driver on Mars, the user interface 104 will display question 108, and if the reader can correctly answer question 108, calculating the time taken to comprehend passage 106, the reading level will be updated. If the user can answer question 108 correctly at a fixed time, then the reading level will be increased.

Additionally, user profile details 114 are collected in parallel to the selection of the word. The details other than user profile details 114 are collected separately from the online learning platform 102. For example, the adjacent text, for a sentence such as “People have been sending Robots to Mars for years. These robots are called rovers,”. In the sentence above, the user does not know the meaning of the word “rovers,”. When the user selects the word then the word rover will get fetched by the data collector 118 and the whole sentence will be fetched by the passage 106.

The definition generation system 100 updates the user's reading level in real-time through interactions with the user interface 102. It presents question 108 to the user after they complete the reading passage 106. When the user successfully answers these questions 108, the definition generation system 100 updates their reading level. Additionally, the definition generation system 100 analyzes the user's performance by measuring the time they take to complete the questions.

In operation 206, a prompt generator 122 generates a prompt to guide the AI engine 124 based on the selected word, user preferences, the user's reading level, and the context of the selected word within the passage 106. Following is an exemplary prompt to

```
You are a reading tutor helping children learn to read. Your task
is to define a given word in context, using a reading level
appropriate for the child's lexile level. Output the definition
in JSON format.
Input JSON structure:
{
  “word”: “String”,
  “lexileLevel”: “String”,
  “context”: “String”
}
Output JSON format:
{
  “word”: “String”,
  “phonetic”: “String”,
  “meanings”: [
    {
      “partOfSpeech”: “String”,
      “definitions”: [
        {
          “definition”: “String”
        }
      ]
    }
  ]
}
Instructions:
1. Use the provided lexile level to adjust the complexity of the
definition. If no lexile level is provided, estimate it based on
the context.
2. Define the word in a way that is understandable within the
given context.
3. Use the International Phonetic Alphabet for the phonetic
spelling of the word.
4. Ensure the definition is relevant to the context and
appropriate for the child's reading level.
5. Provide a single, most relevant definition. If multiple
definitions are necessary, include them in the “meanings” array.
6. Do not repeat the context in the definition.
7. If the word is a compound word, include the meanings of the
individual words that make up the compound word.
8. Adhere strictly to the output JSON format.
```

The prompt generator 122 utilizes NLP (Natural Language processing) techniques using a NLP (Natural Language Processor) 120. The NLP 120 is integrated within the definition generation planner 116. The prompt generator 122 takes the data from the data collector 118 and utilizes it to populate the prompt structure provided by the prompt engineer.

The prompt is further populated by the prompt generator 122 is given below:

```
Input JSON structure:
{
  “word”: “String”,
  “lexileLevel”: “String”,
  “context”: “String”
}
Output JSON format:
{
  “word”: “String”,
  “phonetic”: “String”,
  “meanings”: [
    {
      “partOfSpeech”: “String”,
      “definitions”: [
        {
          “definition”: “String”
        }
      ]
    }
  ]
}
Instructions:
1. Use the provided lexile level to adjust the complexity of the definition.
If no lexile level is provided, estimate it based on the context.
2. Define the word in a way that is understandable within the given context.
3. Use the International Phonetic Alphabet for the phonetic spelling of the
word.
4. Ensure the definition is relevant to the context and appropriate for the
child's reading level.
5. Provide a single, most relevant definition. If multiple definitions are
necessary, include them in the “meanings” array.
6. Do not repeat the context in the definition.
7. If the word is a compound word, include the meanings of the individual
words that make up the compound word.
8. Adhere strictly to the output JSON format.
Example 1:
Input: {“word”: “run”, “lexileLevel”: “500L”, “context”: “The children run in
the park every day.”}
Output: {“word”: “run”, “phonetic”: “rΛn”, “meanings”: [{“partOfSpeech”:
“verb”, “definitions”: [{“definition”: “to move quickly on foot”}]}]}
Example 2:
Input: {“word”: “photosynthesis”, “lexileLevel”: “800L”, “context”: “Plants
use photosynthesis to convert sunlight into energy.”}
Output: {“word”: “photosynthesis”, “phonetic”: “ , fo [symbol]   to [symbol]   ‘ s [symbol]   nθ [symbol]   s [symbol]   s”,
“meanings”: [{“partOfSpeech”: “noun”, “definitions”: [{“definition”: “the
process by which green plants use sunlight to make their own food”}]}]}
Example 3:
Input: {“word”: “photosynthesis”, “lexileLevel”: “1200L”, “context”: “Plants
use photosynthesis to convert sunlight into energy.”}
Output: {“word”: “photosynthesis”, “phonetic”: “ , fo [symbol]   to [symbol]   ‘ s [symbol]   nθ [symbol]   s [symbol]   s”,
“meanings”: [{“partOfSpeech”: “noun”, “definitions”: [{“definition”: “the
process by which green plants and some other organisms use sunlight to
synthesize foods with the help of chlorophyll”}]}]}
```

In operation 208, the prompt generator 122 transfers the generated prompt to the AI engine 124 to generate the contextually relevant definition of the selected word by the user using a definition generator 126.

The definition generator 126 is integrated within the AI engine 124. The AI engine 124 is operatively coupled to the definition generation planner 116. The definition generator 126 is configured to generate both the definition and phonetic spelling. The definition and the phonetic spelling provides the part of speech, thereby creating a contextually relevant, reading-level-appropriate definition. The generated by the definition generator 126 is in JSON format.

In operation 210, the definition generator 126 provides the contextually relevant definition of the selected word by the user. The definition is generated following the user's reading level and the context of passage 106.

The generated definition is displayed to the user on the user interface 104 of the online learning platform 102. The AI engine 128, working in conjunction with the definition generator 126, produces the required information. This streamlined definition generation process 200 ensures that users receive immediate, context-specific help for unfamiliar words.

The definition generation system 100 further includes a feedback module 128, which is operatively coupled to the online learning platform 102 and the definition generation planner 116. The feedback module 128 adjusts the user's reading level based on their performance in quizzes. If a user consistently answers questions correctly, the feedback module 128 might increase their reading level, indicating they're ready for more challenging material. Conversely, if a user struggles, the feedback module 128 might lower the level to provide content that's easier to understand. This personalized approach helps users better understand the material and supports their learning progression.

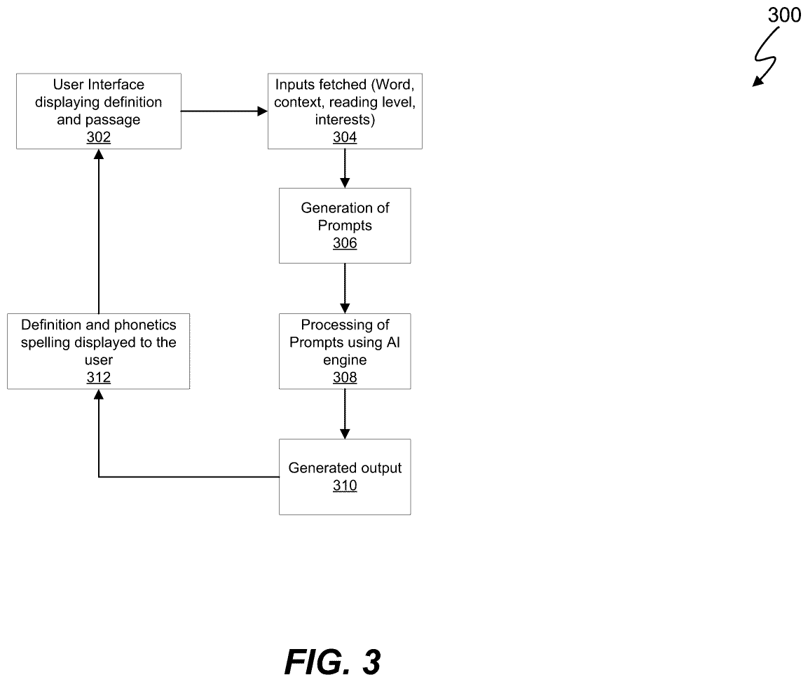

FIG. 3 depicts a flowchart 300 showing the steps of definition generation within the online learning platform 102 when the user faces difficulty in understanding the meaning of a word.

The steps of definition generation within the online learning platform 102, when the user faces difficulty understanding the meaning of a word, are disclosed herein. The user interface 104 contains the passage and questions 302, as the user finds difficulty understanding the word meaning in a passage 106. The data collector 118 fetches the input data 304, including the selected word, context of the selected word in the passage from the user selection, and user interests, and reading level of the user using the user profile details 114 stored in the memory 112 of the online learning platform 102.

A prompt engineer generates a prompt structure which includes the basic structure of the prompt along with the rules and guidelines to generate the prompt. The prompt generator 122 generates a prompt 306 by populating the prompt structure by using the collected input which includes the word, the context of the word, reading level, and user interest. The AI engine 128 receives the generated prompt 308. The AI engine 128, after processing the prompt, generates output in JSON format. The definition generator 132 receives the output in JSON format, which is then converted to natural language. The definition generator 132 sends the converted natural language 312 into the user interface 104. In the user interface 104, the reader can access this in real-time.

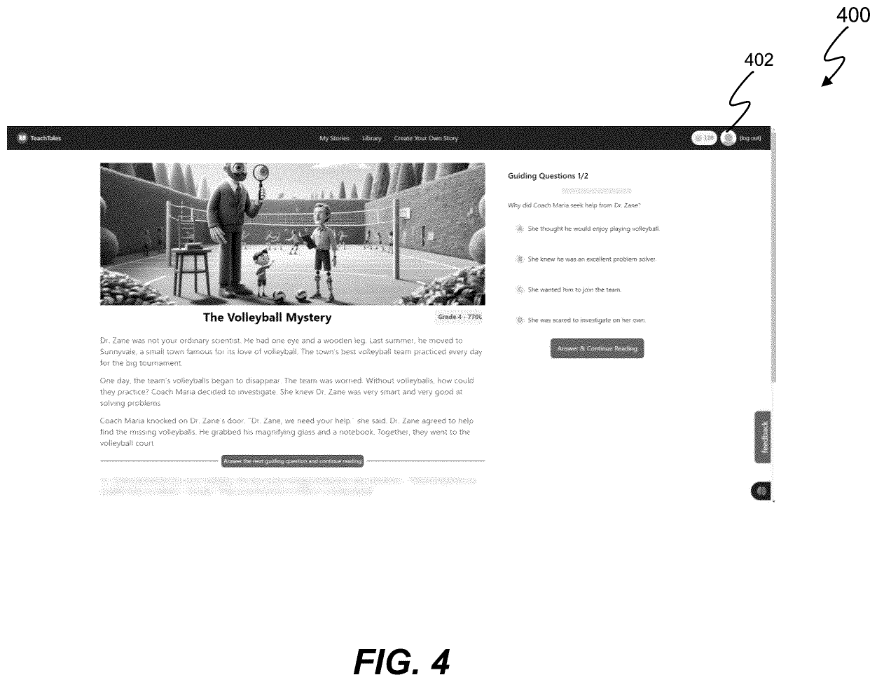

FIG. 4 depicts an exemplary user interface 400 disclosing a passage 106 and quiz questions 108 that are read by the user.

The user interface 400 has multiple functions within the online learning platform 102. The user interface 104 displays the passage 106 that the user is currently reading, alongside a user profile section 402 that stores data on the user's performance and preferences. The user interface 104 also includes comprehension questions 108 to test the reader's understanding of the material. For instance, after a user finishes reading the passage 106 about a physicist training a student in volleyball, the AI engine 128 generates the questions 108 related to the passage 106 that are displayed to the user on the online learning platform 102. These questions 108 are designed to assess the user's comprehension skills and examine the user's reading level, based on which the passage is generated. The definition generation system 100 then utilizes AI engine 128 to evaluate the user's responses to update their reading level accordingly. If the reader answers the question 108 correctly, demonstrating good comprehension, their reading level increases. However, if they struggle with the question 108, their reading level remains unchanged or decreases if they continuously keep on giving wrong answers. This dynamic assessment process allows the online learning platform 102 to continuously adapt to the user's reading ability, ensuring that the content and challenges presented remain appropriate and engaging for the individual user.

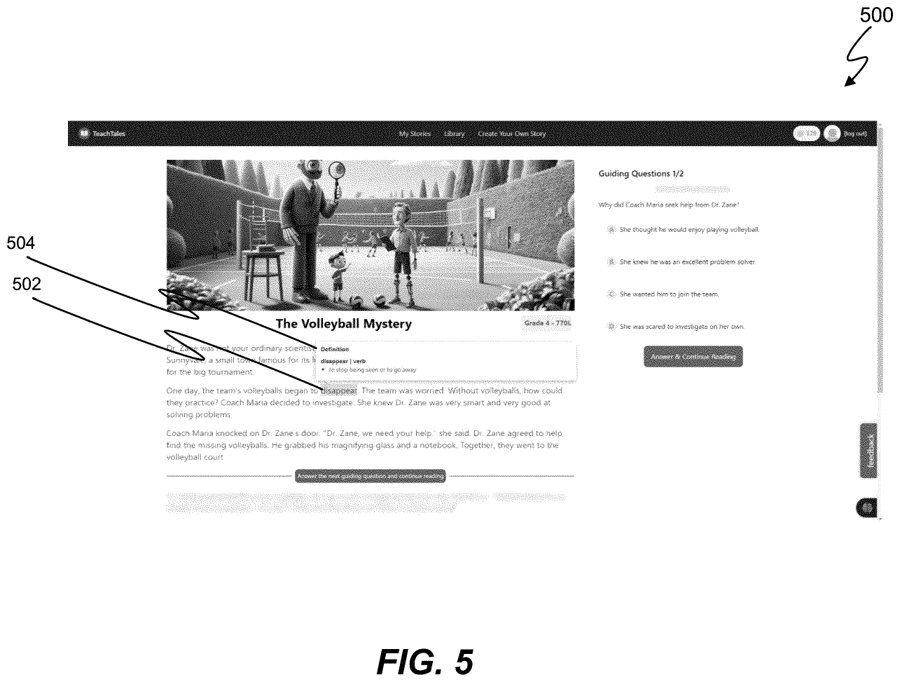

FIG. 5 depicts an exemplary user interface 500 disclosing the selection of word 502 by the user and the definition 504 of the selected word, which the user faces difficulty while reading.

The user while going through the passage undergoes a problem in understanding the meaning of some words and selects the word 502, for instance, ‘DISAPPEARED’. The AI engine 128 utilizes definition generator 132 integrated within it and generates the definition of the selected word 502. Importantly, the definition generator 132 provides a definition 504 that is appropriate to the specific context of the sentence where the word appears.

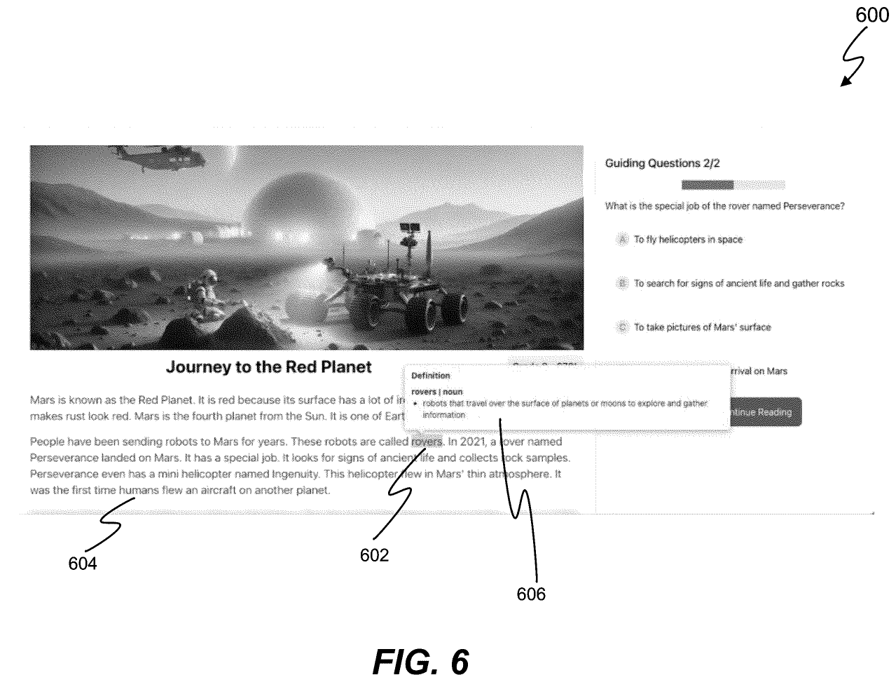

FIG. 6 depicts an exemplary user interface 600 disclosing the definition of the word 602 selected by the user in context with the passage 604.

The user while going through the passage 604 undergoes a problem in understanding the meaning of some words and selects the word 602, for instance, ‘ROVER’. The AI engine 128 utilizes definition generator 132 integrated within it and generates the definition 606 of the selected word 602. Importantly, the definition generator 132 provides a definition that is appropriate to the specific context of the sentence where the word appears.

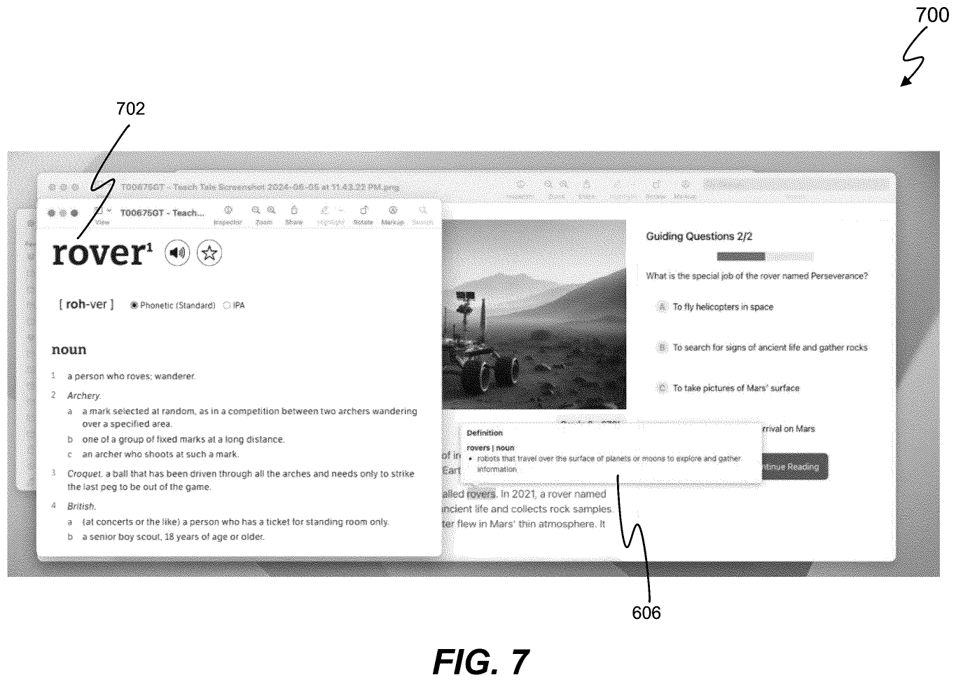

FIG. 7 depicts an exemplary user interface 700 disclosing the comparison between the definition of the selected word and the general definition of the word 602 found in the web 702.

The user interface 600 displays the difference between the meaning given by the definition found on the web and the AI-driven definition generation system 100. The web-based definition 702 for the selected word “ROVER” is given as “a person who roves, wanderer” followed by different other definitions, and the AI-driven definition generation system 100 has given the definition 606 according to the context of the passage which is “robots that travel over the surface of the planet or moon to explore and gather information”.

This shows that the definition generation system 100 utilizes the definition generator 132 integrated within the AI engine 128 and generates the definition of the selected word in context with passage 604.

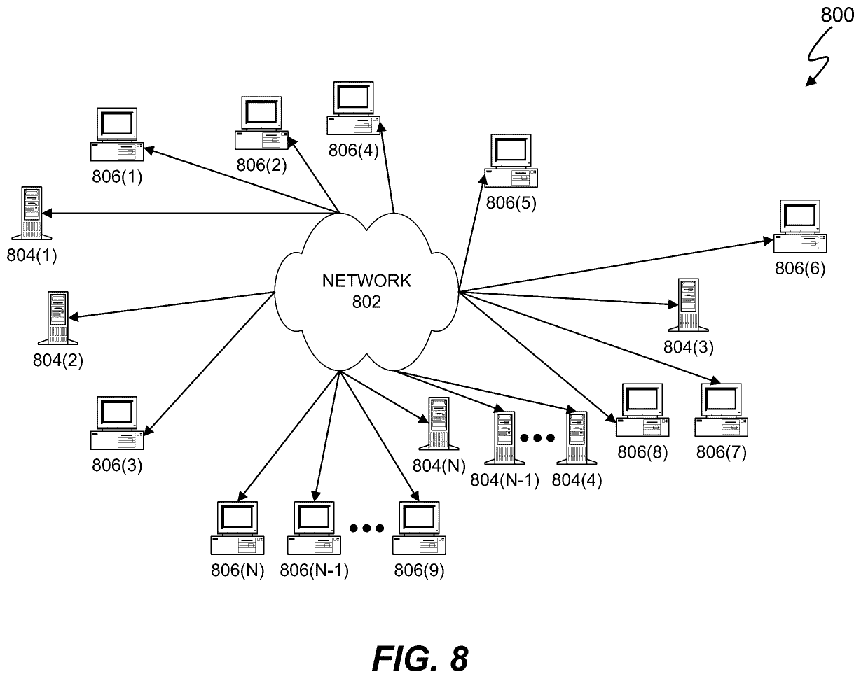

FIG. 8 is a block diagram illustrating a network environment in which a definition generation system 100 and a process 200 within an online learning platform 102 may be practiced. Network 802 (e.g. a private wide area network (WAN) or the Internet) includes several networked server computer systems 804(1)-(N) that are accessible by client computer systems 806(1)-(N), where N is the number of server computer systems connected to the network. Communication between client computer systems 806(1)-(N) and server computer systems 804(1)-(N) typically occurs over a network, such as a public switched telephone network over asynchronous digital subscriber line (ADSL) telephone lines or high-bandwidth trunks, for example, communications channels providing T1 or OC3 service. Client computer systems 806(1)-(N) typically access server computer systems 804(1)-(N) through a service provider, such as an internet service provider (“ISP”) by executing application-specific software, commonly referred to as a browser, on one of client computer systems 806(1)-(N).

Client computer systems 806(1)-(N) and server computer systems 804(1)-(N) are specialized computers programmed to improve conventional computer systems to implement and utilize the definition generation system 100 and process 200 within the online learning platform 102. The type of computer system that can be specially programmed to implement and utilize the definition generation system 100 and process 200 within the online learning platform 102 includes a mainframe, a mini-computer, a personal computer system including notebook computers, a wireless, mobile computing device (including personal digital assistants, smartphones, and tablet computers). These computer systems are typically designed to provide computing power to one or more users locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the definition generation system 100 and process 200 within the online learning platform 102 can be implemented using code stored in a tangible, non-transient computer-readable medium and executed by one or more processors. In at least one embodiment, the definition generation system 100 and process 200 within the online learning platform 102 can be implemented completely in hardware using, for example, logic circuits and other circuits including field programmable gate arrays.

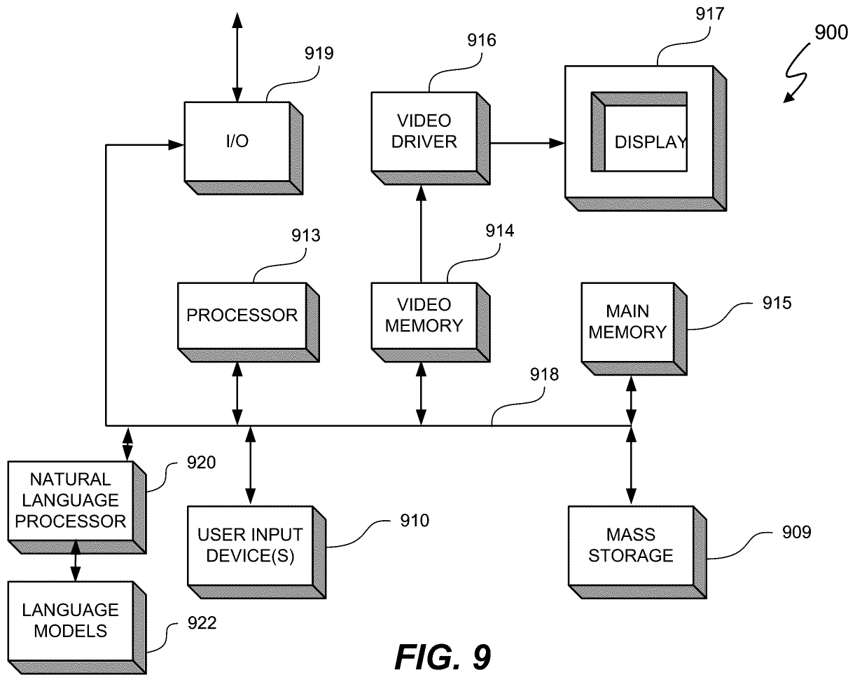

Embodiments of the definition generation system 100 and process 200 within the online learning platform 102 can be implemented on a computer system such as a special-purpose, special-programmed computer 900 illustrated in FIG. 9. Input user device(s) 910, such as a keyboard and/or mouse, are coupled to a bi-directional system bus 918. The input user device(s) 910 are for introducing user input to the computer system and communicating that user input to processor 913. The computer system of FIG. 9 generally also includes a non-transitory video memory 914, non-transitory main memory 915, and non-transitory mass storage 909, all coupled to bi-directional system bus 918 along with input user device(s) 910 and processor 913. The mass storage 909 may include fixed and removable media, such as a hard drive, one or more CDs or DVDs, solid state memory including flash memory, and other available mass storage technology. Bus 918 may contain, for example, 32 of 64 address lines for addressing video memory 914 or main memory 915. The system bus 918 also includes, for example, an n-bit data bus for transferring DATA between and among the components, such as CPU 909, main memory 915, video memory 914, and mass storage 909, where “n” is, for example, 32 or 64. Alternatively, multiplex data/address lines may be used instead of separate data and address lines.

I/O device(s) 919 may provide connections to peripheral devices, such as a printer, and may also provide a direct connection to a remote server computer system via a telephone link or to the Internet via an ISP. I/O device(s) 919 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 909, into main memory 915 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 913, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 915 consists of dynamic random access memory (DRAM). Video memory 914 is a dual-ported video random access memory. One port of the video memory 914 is coupled to the video amplifier 916. The video amplifier 916 is used to drive the display 917. Video amplifier 916 is well-known in the art and may be implemented by any suitable means. This circuitry converts pixel DATA stored in video memory 914 to a raster signal suitable for use by display 917. Display 917 is a type of monitor suitable for displaying graphic images.

The computer system described above is for purposes of example only. The definition generation system 100 and process 200 within the online learning platform 102 may be implemented in any type of computer system programming or processing environment. It is contemplated that the definition generation system 100 and process 200 within the online learning platform 102 might be run on a stand-alone computer system, such as the one described above. The definition generation system 100 and process 200 within the online learning platform 102 might also be run from a server computer systems system that can be accessed by a plurality of client computer systems interconnected over an intranet network. Finally, the definition generation system 100 and process 200 within the online learning platform 102 may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method that integrates programmatic control and a guided and constrained Artificial Intelligence (AI) engine to provide contextually relevant word definitions of words present in a passage, the method comprises:
executing code using one or more processors of a computer system to cause the computer system to perform operations comprising:
selecting a word by the user, reading the passage on the online learning platform, wherein the selected word is the word whose meaning is difficult to understand by the user;
fetching user details from user profile including, user preferences, user's reading level, and text adjacent to the selected word, wherein the text adjacent to the selected word is used for determining the context of the selected word within the passage;
generating a prompt to guide the AI engine based on the selected word, user preferences, the user's reading level, and the context of the selected word within the passage;
transferring the generated prompt to the AI engine to generate the contextually relevant definition of the selected word by the user;
receiving the contextually relevant definition of the selected word by the user, wherein the definition is generated following the user's reading level and the context of the passage.

2. The method of claim 1 wherein the user can click on any word within the reading passage to receive an instant definition that is age-appropriate and contextually relevant.

3. The method of claim 1 wherein the reading level of the user can be directly entered by the user on the online learning platform or can be selected based on user profile details, if not entered by the user.

4. The method of claim 1 wherein the complexity and relevance of the word are dynamically adjusted based on the user's reading level and the specific content of the passage.

5. The method of claim 1 wherein the context of the selected word includes identifying the genre and subject matter of the passage to enhance the relevance of the definition.

6. The method of claim 1 wherein the output includes the word, its phonetic spelling, part of speech, and a contextually relevant, reading level-appropriate definition.

7. The method of claim 1 wherein the contextually relevant definition of the selected word is received in JSON format.

8. The method of claim 1 wherein the reading level of the user is updated in real-time based on the interaction of the user with the online learning platform and quiz results.

9. The method of claim 1 ensures that the definitions generated are contextually relevant even if the same word is requested multiple times under different contexts or reading levels, thereby enhancing comprehension and engagement.

10. The method of claim 1 further comprises:
collecting details from quizzes answered by the user, including the correctness and response time of the user's answers;
updating the user's reading level based on the collected quiz details; and
utilizing the updated reading level to generate contextually relevant definitions of words, ensuring the definitions are appropriate for the user's current reading ability.

11. The method of claim 1 wherein the AI engine is configured to generate multiple definitions for a word, each generated in correspondence to different possible contexts within the passage.

12. A system that integrates programmatic control and a guided and constrained Artificial Intelligence (AI) engine to provide contextually relevant word definitions of words present in a passage, the system comprising:
one or more processors of a computer system; and
a memory, coupled to the one or more processors, storing code that when executed causes the computer system to perform operations comprising:
selecting a word by the user, reading the passage on the online learning platform, wherein the selected word is the word whose meaning is difficult to understand by the user;
fetching user details from user profile including, user preferences, user's reading level, and text adjacent to the selected word using a data collector, wherein the text adjacent to the selected word is used for determining the context of the selected word within the passage;
generating a prompt by a prompt generator to guide the AI engine based on the selected word, user preferences, the user's reading level, and the context of the selected word within the passage;
transferring the generated prompt to the AI engine to generate the contextually relevant definition of the selected word by the user using a definition generator;
receiving the contextually relevant definition of the selected word by the user using the definition generator, wherein the definition is generated following the user's reading level and the context of the passage.

13. The system of claim 12 further comprises:
a user interface integrated within the online learning platform that displays the contextually relevant definition of the selected word by the user.

14. The system of claim 12 wherein the data collector is further configured to update the user's reading level dynamically based on their interaction with the online learning platform and performance in quizzes or assessments.

15. The system of claim 12 wherein the prompt generator utilizes a natural language processor (NLP) to refine the prompt for better accuracy and relevance.

16. The system of claim 12 wherein the output is presented in a structured and user-friendly format for display.

17. The system of claim 12 wherein a feedback module updates the user's reading level based on quiz performance and generates updated contextually relevant definitions according to the revised reading level.
